(19) United States
(12) Patent Application Publication
(10) Pub. No.: US 2010/0088341 A1
(43) Pub. Date: Apr. 8, 2010

(54) COMPUTING DATA SECURITY SETTINGS IN A MULTI-DIMENSIONAL SYSTEM

(76) Inventors: CHRISTIAN AH-SOON, Franconville (FR); MARC FERENCZI, Paris (FR); FABIEN KOBUS, Sevres (FR)

Correspondence Address: SAP AG, 3410 HILLVIEW AVENUE, PALO ALTO, CA, 94304, US

(21) Appl. No.: 12/247,242

(22) Filed: Oct. 8, 2008

(51) Int. Cl. G06F 17/30

(52) U.S. Cl. 707/783; 707/E17.056

(57) ABSTRACT

Disclosed is a method and system for computing data security settings in a multi-dimensional system. The method includes receiving a query from a user to access a dataset, retrieving a membership tree of the user and determining a set of minimal branches of the membership tree. A minimal data security setting for the user is determined by computing a sum of products in the set of minimal branches. A data security setting for the user to access the dataset is determined based on the minimal data security setting and finally, the data security setting is embedded in the query to access the dataset.

### FIELD OF THE INVENTION

The invention generally relates to the field of multi-dimensional systems. More particularly the invention relates to computing data security settings in the multi-dimensional systems.

### BACKGROUND OF THE INVENTION

A multidimensional database is a type of database that is optimized for data warehouse and online analytical processing (OLAP) applications. Multidimensional databases are frequently created using input from existing relational databases. The multidimensional database allows storing of information in such a way that a user can get answers to questions like “How many mobile phones have been sold in San Francisco so far this year?” and similar questions related to summarizing business operations and trends. An OLAP application enables accessing data from the multidimensional database. The multidimensional database uses the concept of a data cube to enable a rapid processing of the data in the database so that answers can be generated quickly. The data available to the user is organized as cells of the data cube. The data cube is an OLAP cube that represents data available to a user in various dimensions like products, people, financial elements, and time and metrics like sales revenue in terms of number of units sold or dollars. The user may want to view data such as what is the sales revenue data for a particular customer? What is the sales revenue data for a particular country? What is the sales revenue data for a particular quarter or year?

In an enterprise with a large number of employees, ensuring only authorized people get access to right data is important. For example, an employee in India may view only the sales data of India but not the sales data of North America. Another employee may view total sales data but may not view sales data of a particular product or customer or geography. Another employee may be able to see the sales data for a product only in terms of the number of units sold and not in terms of US dollars. So, the sales data may be restricted in terms of dimensions such as customer, product, time and geography and in terms of metrics such as units sold and dollars. So, to determine whether data may be accessed by a user, it is necessary to determine data security settings of dimensions and metrics for the user.

In the current multi dimensional systems, such data security settings are typically stored in a database as binary values such as 0 and 1. The disadvantage of such a method is that it is complex and tedious to configure the data security settings since they are not in human readable format. Also, the configuration of such data security settings is complicated since they have to be maintained with every piece of data in the database accessible to the user. Since the data security settings are stored with the data source, they tend to consume huge amounts of storage space.

### SUMMARY OF THE INVENTION

Described are methods and systems for computing data security settings in a multi-dimensional system. The methods include receiving a query from a user to access a dataset, retrieving a membership tree of the user and determining a set of minimal branches of the membership tree. A minimal data security setting for the user is determined by computing a sum of products in the set of minimal branches. A data security setting for the user to access the dataset is determined based on the minimal data security setting and finally, the data security setting is embedded in the query to access the dataset.

### BRIEF DESCRIPTION OF THE DRAWINGS

FIG. 1 is a block diagram of a data cube in an online analytical processing (OLAP) application according to an embodiment of the invention.

FIG. 2 is a block diagram of a system to compute data security settings for accessing a dataset according to an embodiment of the invention.

FIG. 3 is a membership tree of a user according to an embodiment of the invention.

FIG. 4 is a flow diagram for computing the data security setting to access a dataset by a user having a membership to user groups depicted in FIG. 3 according to an embodiment of the invention.

FIG. 5 is a flow diagram for determining a set of minimal branches in the membership tree of FIG. 3 according to an embodiment of the invention.

FIG. 6 is a flow diagram for determining a minimal data security setting for a user in the membership tree of FIG. 3 according to an embodiment of the invention.

FIG. 7 is a detailed block diagram of a system for computing the data security setting for accessing the dataset according to an embodiment of the invention.

### DETAILED DESCRIPTION

Described are methods and systems for computing data security settings in a multi-dimensional system. The method includes receiving a query from a user to access a dataset, retrieving a membership tree of the user and determining a set of minimal branches of the membership tree. A minimal data security setting for the user is determined by computing a sum of products in the set of minimal branches. A data security setting for the user to access the dataset is determined based on the minimal data security setting and finally, the data security setting is embedded in the query to access the dataset.

The data security settings are stored in a minimal form which can be used to determine the complete data security setting at a later point of time when the user requests access to the dataset. The computations of the data security settings occur outside a data source which makes it easy for configuring the data security settings. The data security settings are stored in a human readable format so that it is easy to understand and configure. An organization may define its own security policies and make various users and user groups as members of various security policies. In this way, a data security setting for the user to access the dataset need not be stored in a database instead it may be determined when the user requests the access to the dataset.

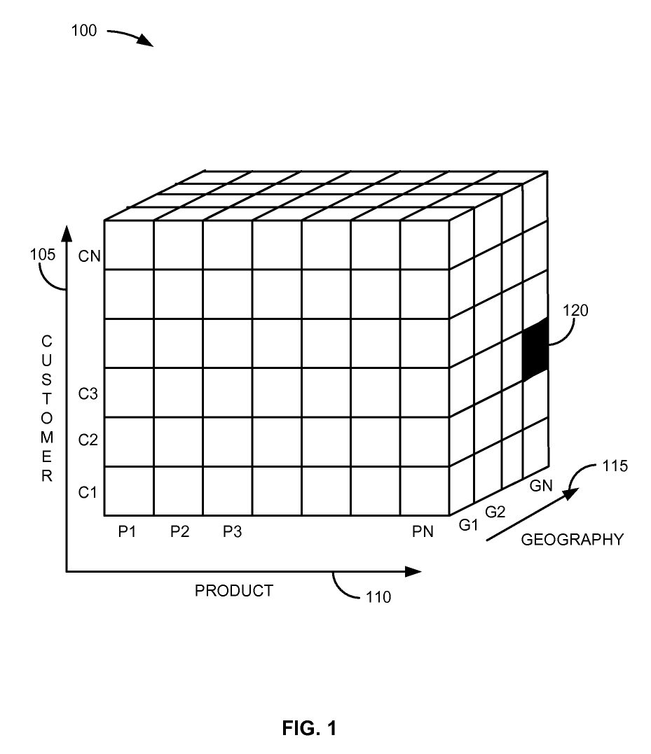

FIG. 1 is a block diagram of a data cube in an online analytical processing (OLAP) application according to an embodiment of the invention. The data cube 100 is an OLAP cube that represents data available to a user in various dimensions. A dimension represents sets of enumerable business entities like products, people, financial elements, and time. For example, “sales revenue data” could be viewed in dimensions of customer, product, geography, time and some additional dimensions. Each axis in data cube 100 represents data from dimensions such as customer 105, product 110 and geography 115. In data cube 100, “sales revenue data” is known as the measure attribute of data cube 100. A measure or a metric is a quantity as ascertained by comparison with a standard, usually denoted in some metric, for example, units sold and dollars. A measure, such as sales revenue, can be displayed for the dimension customer 105, product 110 and geography 115. The sales data is organized as cells in data cube 100. For example, dataset 120 indicated in the cell with coordinates (C3, PN, GN) specifies that dataset 120 contains sales data of customer “C3” for product “PN” in geography “GN”. An OLAP application facilitates obtaining data from data cube 100. So, to determine whether dataset 120 may be accessed by a user, it is necessary to determine data security settings of dimensions customer 105, product 110 and geography 115 and metrics such as units sold and dollars.

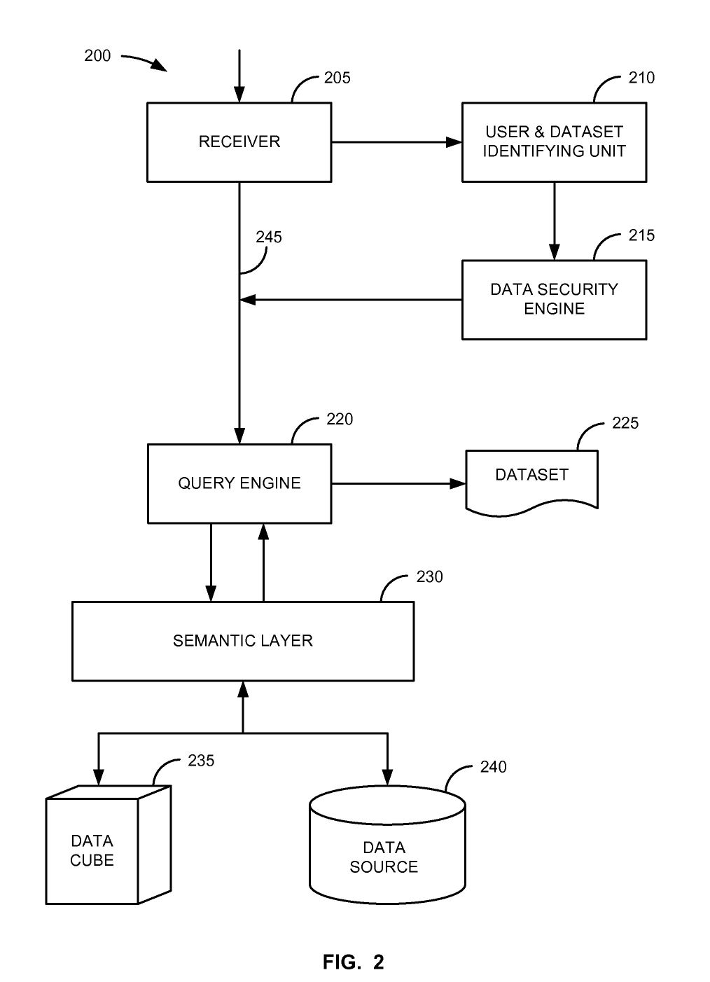

FIG. 2 is a block diagram of a system to compute data security settings for accessing a dataset according to an embodiment of the invention. System 200 includes a receiver 205 to receive a query from a user to access dataset 225. The dataset 225 may be obtained from data cube 235 of a multi-dimensional database or from other data source 240 such as a relational database. The identifying unit 210 identifies the user and the dataset to which the access is requested. The data security engine 215 connected to the identifying unit 210 determines data security settings for the user to access dataset 225. The data security engine 215 determines data security settings for the user to access the dataset by aggregating data security settings of the user, user groups to which the user belongs, dimension and metric of dataset 225. The data security settings determine which data in a dimension and which metric data of data cube 235 may be accessed by the user. For example, one such data security setting for a user “Bob” may specify that Bob can view sales data for United States of America but not for India. Further, the data security setting may also specify that Bob may view the sales data only for cities “New York” and “San Francisco” within the United States. The data security settings may also specify that Bob can view only certain metrics of sales data such as number of units of a product sold but not the sales data in terms of dollars.

After determining data security settings for the user to access dataset 225, data security engine 215 embeds the data security settings into the query 245 from receiver 205. The query engine 220 executes the query 245 with the embedded data security settings to obtain dataset 225 from semantic layer 230. The semantic layer 230 obtains dataset 225 from data cube 235 or any other data source 240.

The semantic layer 230 is a business representation of enterprise data that helps end users access data autonomously using common business terms. The semantic layer 230 provided by Business Objects of San Jose, Calif., USA maps complex data into familiar business terms such as product, customer, or revenue to offer a unified, consolidated view of data across the organization. The semantic layer 230 can be a level of abstraction based on a relational, OLAP, or other data source or a combination of more than one existing semantic layers. The semantic layer 230 includes data model objects that describe the underlying data source and define dimensions, attributes and measures that can be applied to the underlying data source.

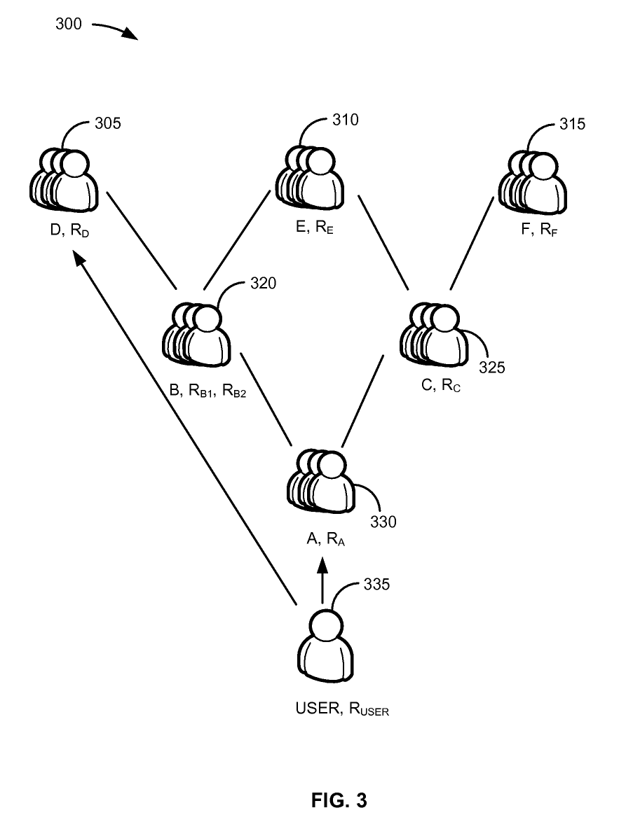

FIG. 3 is a membership tree of a user according to an embodiment of the invention. A user 335 requesting access to a dataset belongs to one or more user groups. A membership tree 300 depicts membership of user 335 with various user groups such as user group A 330, user group B 320, user group C 325, user group D 305, user group E 310, and user group F 315 in a tree format with branches and nodes. The user 335 and the user groups the user belongs to form the nodes of membership tree 300. For example, the user group may include a sales executives group, sales managers group, sales directors group, system administrator group, product management group and manufacturing group. The nature of the user groups are such that they demand only the necessary data be available to a particular user group. That is, each of the user groups has specific data security settings which may allow or deny access to a particular dataset. For example, the user 335 may have permissions to view only sales data in New York. The user group A 330 may have permissions to view sales data in the whole of United States. Further, user group A 330 may have permissions to view sales data in terms of dollars whereas the user 335 may view sales data only in terms of number of units sold. Therefore, the data access settings for user 335 depends upon an aggregation of data security settings of user 335 and the user groups such as user group A 330, user group B 320, user group C 325, user group D 305, user group E 310, and user group F 315 to which user 335 belongs. In membership tree 300, the data security setting of user 335 is denoted by R_{USER}, user group A 330 by R_{A}, user group B 320 by R_{B1} and R_{B2}, user group C 325 by R_{C}, user group D 305 by R_{D}, user group E 310 by R_{E}, and user group F 315 by R_{F}.

The membership tree 300 denotes that user 335 is a direct member of user group A 330 and user group D 305. The user 335 becomes an indirect member of the user group B 320, user group C 325, user group E 310, and user group F 315 since the user group A 330 and user group D 305 are members of the above groups. Therefore, to determine the data security settings for user 335 to access a data set, it is necessary to aggregate the data security setting of user 335 and the user groups to which the user belongs directly or indirectly.

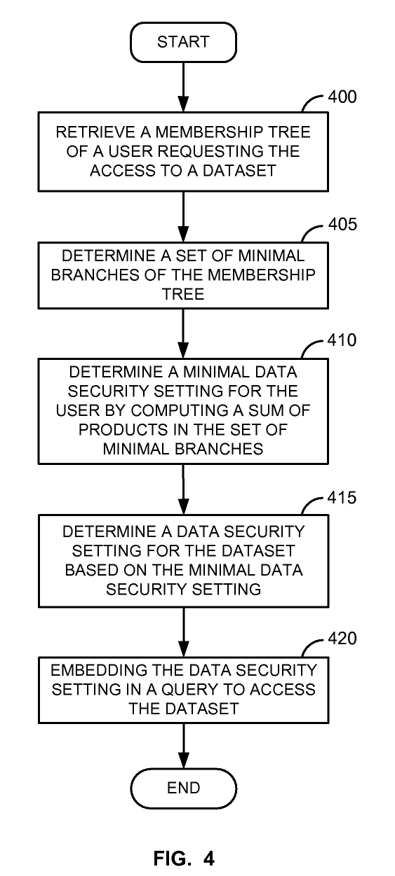

FIG. 4 is a flow diagram for computing the data security setting to access a dataset by a user having a membership to user groups depicted in FIG.3 according to an embodiment of the invention. After receiving a query to access a data set, at step 400, a membership tree 300 of user 335 is retrieved from a data store. Also, the dataset to which user 335 has requested access to is identified. For example, if user 335 has requested access to sales data, then an OLAP cube such as a sales cube is determined as a data provider for the sales data.

At step 405, a set of minimal branches of membership tree 300 is determined. A minimal branch is a smallest branch in membership tree 300 that necessarily determines a data security setting for user 335 to access the dataset. In other words, a minimal branch is the shortest path between the nodes. The set of minimal branches, MB, for the user in membership tree 300 are determined as below:

MB={D, ABE, ACE, ACF}

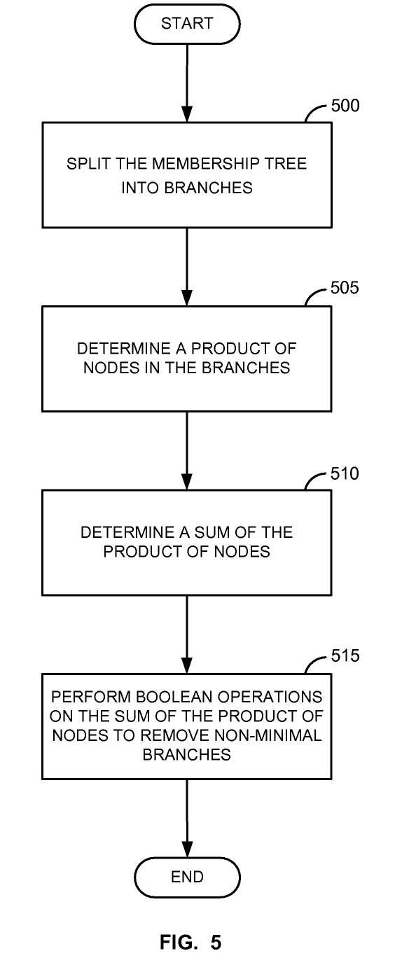

The details of determining the set of minimal branches are explained in FIG. 5. After determining the set of minimal branches, at step 410, the minimal data security setting of the set MB is determined by computing a sum of products on the data security settings of the user groups in the set of minimal branches. A minimal data security setting is a data security setting determined for the minimal set of branches, MB. The sum of products MB_{SOP} of the user groups in the set of minimal branches, set MB, is computed as

MB_{SOP}=D+ABE+ACE+ACF

Now, the minimal data security settings, DSS_{MINIMAL}, is computed by substituting the user groups in the sum of products with their respective data security settings and adding the data security setting of the user as a leading factor as below:

DSS_{MINIMAL}=R_{USER}(R_{D}+R_{A} R_{B1} R_{B2} R_{E}+R_{A} R_{C} R_{E}+R_{A} R_{C} R_{F})

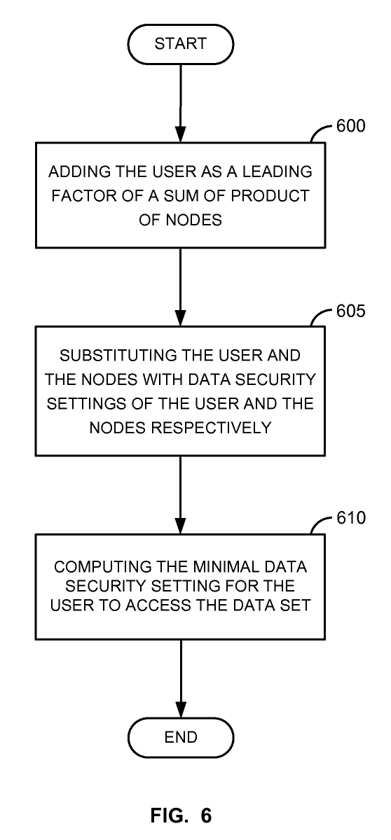

The details of determining the minimal data security settings are explained in FIG. 6. After determining the minimal data security setting, DSS_{MINIMAL}, at step 415, the data security setting for the user to access the dataset is aggregated based on the minimal data security setting for a particular dimension and a metric of the dataset. The minimal data security setting for a dimension and a metric are represented as DSS_{USER, DIMENSION}, and DSS_{USER, METRIC} respectively. For example, if a dataset has dimension geography and a metric sales margin, then the data security setting, DSS_{USER, GEOGRAPHY}, and DSS_{USER, MARGIN} is computed based on the DSS_{MINIMAL} shown above.

### Determining Data Security Setting, DSS_{USER, GEOGRAPHY}, for Dimension GEOGRAPHY

Since the data security setting for a dimension is a set, set operations are performed on data security settings of the user 335 and user groups.
DSS_{USER, GEOGRAPHY}=R_{USER, GEOGRAPHY} ∩
[R_{D, GEOGRAPHY} ∪
(R_{A, GEOGRAPHY} ∩ R_{B1, GEOGRAPHY} ∩ R_{B2, GEOGRAPHY} ∩ R_{E, GEOGRAPHY}) ∪
(R_{A, GEOGRAPHY} ∩ R_{C, GEOGRAPHY} ∩ R_{E, GEOGRAPHY}) ∪
(R_{A, GEOGRAPHY} ∩ R_{C, GEOGRAPHY} ∩ R_{F, GEOGRAPHY})]
Where
∩ and ∪ are set operators,
∩ represents an intersection set operation and
∪ represents a union set operation.

The above expression is arrived at by replacing the sum operation in DSS_{MINIMAL} with “∪”, a union operation and a product operation in DSS_{MINIMAL} with “∩” an intersection operation.

For the purpose of evaluating the expression, DSS_{USER, GEOGRAPHY}, let the data security settings of the user and user groups for dimension GEOGRAPHY, in an embodiment be defined, as below:

Dimension GEOGRAPHY has three levels, namely, Country, City and Stores.

R_{USER, GEOGRAPHY}=Φ, R_{A, GEOGRAPHY}=Φ, R_{E, GEOGRAPHY}=Φ,

R_{F, GEOGRAPHY}=Φ, where Φ=FULL SET.

R_{B1, GEOGRAPHY}={All.USA.descendants},

R_{B2, GEOGRAPHY}={All.USA.SanFrancisco.children},

R_{C, GEOGRAPHY}={All.Australia.descendants}, and

R_{D, GEOGRAPHY}={All.India.descendants}

The above data security settings or restrictions R_{USER, GEOGRAPHY}, R_{A, GEOGRAPHY}, R_{E, GEOGRAPHY}, R_{F, GEOGRAPHY} mean that user 335 and user groups A, E, and F have no restrictions for dimension GEOGRAPHY and hence can access all members of the set, that is, the users can access all data in that dimension. R_{B1, GEOGRAPHY} and R_{B2, GEOGRAPHY} are two different data security settings for user group B 320. R_{B1, GEOGRAPHY} states that the user group B 320 may access all cities and stores in USA. R_{B2, GEOGRAPHY} states that user group B 320 may access all stores in San Francisco city. R_{C, GEOGRAPHY} states that user group C 325 may access all cities and stores in Australia. R_{D, GEOGRAPHY} states that user group D 305 may access all cities and stores in India. In an embodiment, if the data security setting is not defined for a user group for a particular dimension, the default value may be a FULL SET, which means that the user group may access all members of a set. For example, if data security setting R_{A, GEOGRAPHY} is not defined, then user group A 330 may access the FULL SET, which is, all countries, all cities, and all stores.

To obtain the data security setting DSS_{USER, GEOGRAPHY}, for user 335, the above data security setting values are substituted in the expression, DSS_{USER, GEOGRAPHY}. Also, if the data security setting is a FULL SET, then these data security settings may not be considered for evaluating the expression. Thus, data security settings R_{USER}, GEOGRAPHY, R_{A, GEOGRAPHY}, R_{E, GEOGRAPHY}, and R_{F, GEOGRAPHY} are eliminated from the expression. Therefore, DSS_{USER, GEOGRAPHY} evaluates to
DSS_{USER, GEOGRAPHY}=[R_{D, GEOGRAPHY} ∪
(R_{B1, GEOGRAPHY} ∩ R_{B2, GEOGRAPHY}) ∪
(R_{C, GEOGRAPHY}) ∪
(R_{C, GEOGRAPHY})]
   Substituting the values of respective data security settings, we get,
DSS_{USER, GEOGRAPHY}=[{All.India.descendants} ∪
({All.USA.descendants} ∩ {All.USA.SanFrancisco.children}) ∪
({All.Australia.descendants}) ∪
{All.Australia.descendants})]
DSS_{USER, GEOGRAPHY}=[{All.India.descendants} ∪
{All.USA.SanFrancisco.children} ∪
{All.Australia.descendants}]

Therefore, user 335 may access all cities and stores in India and all cities and stores in Australia. The user 335 may only access stores in San Francisco and not all cities and stores in USA. Similarly, the data security settings may be determined for other dimensions such as customer, products, employees and time. After determining the data security settings for a dimension, at step 420, the data security setting is embedded in a query to access the dataset.

### Determining Data Security Setting, DSS_{USER, MARGIN,} for Metric SALES MARGIN

The data security setting for a metric is a Boolean value and hence a Boolean operation is performed on the data security settings.
DSS_{USER, MARGIN}=R_{USER, SALES MARGIN} AND
[R_{D, SALES MARGIN} OR
(R_{A, SALES MARGIN} AND R_{B1, SALES MARGIN} AND R_{B2, SALES MARGIN} AND
R_{E, SALES MARGIN)} OR
(R_{A, SALES MARGIN} AND R_{C, SALES MARGIN} AND R_{E, SALES MARGIN}) OR
(R_{A, SALES MARGIN} AND R_{C, SALES MARGIN} AND R_{F, SALES MARGIN})
Where
AND and OR are Boolean operators,
AND represents a Boolean product operation and
OR represents a Boolean sum operation.

The above expression, DSS_{USER, MARGIN,} is arrived at, by replacing a sum operation in DSS_{MINIMAL} with “OR” operation and a product operation in DSS_{MINIMAL} with “AND” operation. The data security setting for a metric may have a Boolean value true or false (i.e. 1 or 0). The user 335 may access the metric only if the data security setting value is true. In an embodiment, if the data security setting for a metric is not defined for a user group, the default value is true, which means the user group may access the metric. For example, if data security setting R_{A, MARGIN} is not defined, then user group A 330 may access the metric, sales margin.

For the purpose of evaluating the expression, DSS_{USER, MARGIN,} let the data security setting for a sales margin metric, in an embodiment, be defined as follows:
R_{USER, SALES MARGIN}=true,
R_{A, SALES MARGIN}=true,
R_{B1, SALES MARGIN}=true,
R_{B2, SALES MARGIN}=false,
R_{C, SALES MARGIN}=false,
R_{D, SALES MARGIN}=false,
R_{E, SALES MARGIN}=true, and
R_{F, SALES MARGIN}=true

Substituting the above Boolean values in the expression, DSS_{USER, MARGIN}:
DSS_{USER, MARGIN}=true AND
[false OR
(true AND true AND false AND true) OR
(true AND false AND true) OR
(true AND false AND true)]
DSS_{USER, MARGIN}=true AND
[false OR
(false) OR
(false) OR
(false)]
DSS_{USER, MARGIN}=true AND [false]
DSS_{USER, MARGIN}=false.
   This means that the access to metric sales margin is denied for user 335.

Similarly, the data security settings are determined for all the metrics requested by the user. After determining the data security settings for the dimension and the metric requested by the user, at step 420, data security settings DSS_{USER, GEOGRAPHY} and DSS_{USER, MARGIN} are embedded in a query to access the dataset. The query with the embedded data security settings retrieves only the dataset that user 335 may access.

FIG. 5 is a flow diagram for determining a set of minimal branches in the membership tree of FIG. 3 according to an embodiment of the invention. After membership tree 300 of user 335 is determined, the set of minimal branches are identified for computing a minimal data security setting for user 335. First, at step 500, membership tree 300 is split into branches. A branch is a unique path starting from a node in a tree to which the user directly belongs, traversing up the tree through a parent node and ending with a root node. The root node is a node which does not have any parent node. For example, in membership tree 300, user 335 is a direct member of user group D 305 and user group A 330. So, the branches of membership tree 300 for user 335 starts with the node user group D 305 and the node user group A 330. There is only one branch starting from node user group D 305, namely, D. There are four branches starting the node user group A 330 and ending with root nodes user group D 305, user group E 310, and user group F 315. They are branches, A→B→D, A→B→E, A→C→E, and A→CΔF. Therefore, the set of branches, set BR, is represented as:
set BR={D,
A→B→D,
A→B→E,
A→C→E,
A→C→F}

After determining the set of branches, at step 505, the product of nodes in the set of branches are determined. The product of nodes in branches D, A→B→D, A→B→E, A→C→E, and A→C→F is determined as D, ABD, ACE, and ACF. Further at step 510, a sum of the product of nodes, SOP, is determined as:

SOP=D+ABD+ABE+ACE+ACF

After determining the sum of the product of nodes, at step 515, a minimal set of branches are determined by eliminating all non-minimal set of branches. A minimal branch is a smallest branch in membership tree 300 that necessarily determines a data security setting for user 335 to access the dataset. In other words, a minimal branch is the shortest path between any two nodes. For example, in the above set of branches, BR, there are two paths between user 335 and user group D 305, namely, D and A→B→D. Therefore the shortest path between the user and user group D 305 is D.

At step 515, all non-minimal branches are eliminated by performing Boolean operations on the sum of the product of nodes. In an embodiment, the Boolean operations are performed based on Boolean Algebra laws that include but not limited to:
Idempotent law which states [(x+x=x), (xx=x)]
Absorption law which states [(xy+x=x)]
Distributive law which states [x(y+z)=xy+xz]
Double Distributive law which states [x+yz=(x+y)(x+z)]

The expression, SOP is simplified by applying one or more of the above laws. Applying the above Boolean operations on, SOP, we get the set of minimal branches, MB_{SOP}, as:

MB_{SOP}=D+ABD+ABE+ACE+ACF

MB_{SOP}=D+ABE+ACE+ACF (by Absorption law)

FIG. 6 is a flow diagram for determining a minimal data security setting for a user in the membership tree of FIG. 3 according to an embodiment of the invention. The minimal data security setting is data security setting determined for the minimal set of branches, MB_{SOP}. The minimal data security setting for user 335 is determined based on the set of minimal branches, MB_{SOP}, obtained above in FIG. 5. After determining the set of minimal branches, MB_{SOP}, at step 600, user 335 is added as a leading factor of the sum of the product of nodes, MB_{SOP}. The minimal data security setting, DSS_{MINIMAL}, is computed as

DSS_{MINIMAL}=USER(D+ABE+ACE+ACF)

At step 605, the user and the user groups in the above expression are substituted with their respective data security settings. Now, DSS_{MINIMAL} evaluates to

DSS_{MINIMAL}=R_{USER}(R_{D}+R_{A} R_{B1} R_{B2} R_{E}+R_{A} R_{C} R_{E}+R_{A} R_{C} R_{F})

At step 610, the above expression is further simplified. In an embodiment, if there are no restrictions defined for a user group, then the terms representing that user group are eliminated from the above expression, DSS_{MINIMAL}. For example, in membership tree 300, since there are no restrictions defined for user group E 310 and user group F 315, the terms R_{E} and R_{F} are eliminated from the expression. Therefore, the expression DSS_{MINIMAL} simplifies to

DSS_{MINIMAL}=R_{USER}(R_{D}+R_{A} R_{B1} R_{B2}+R_{A} R_{C}+R_{A} R_{C})

DSS_{MINIMAL}=R_{USER}(R_{D}+R_{A} R_{B1} R_{B2}+R_{A} R_{C}) (by Idempotent law)

After determining the minimal data security setting, DSS_{MINIMAL}, the data security setting, DSS_{USER, DIMENSION}, and DSS_{USER, METRIC} are determined as explained above in FIG.4.

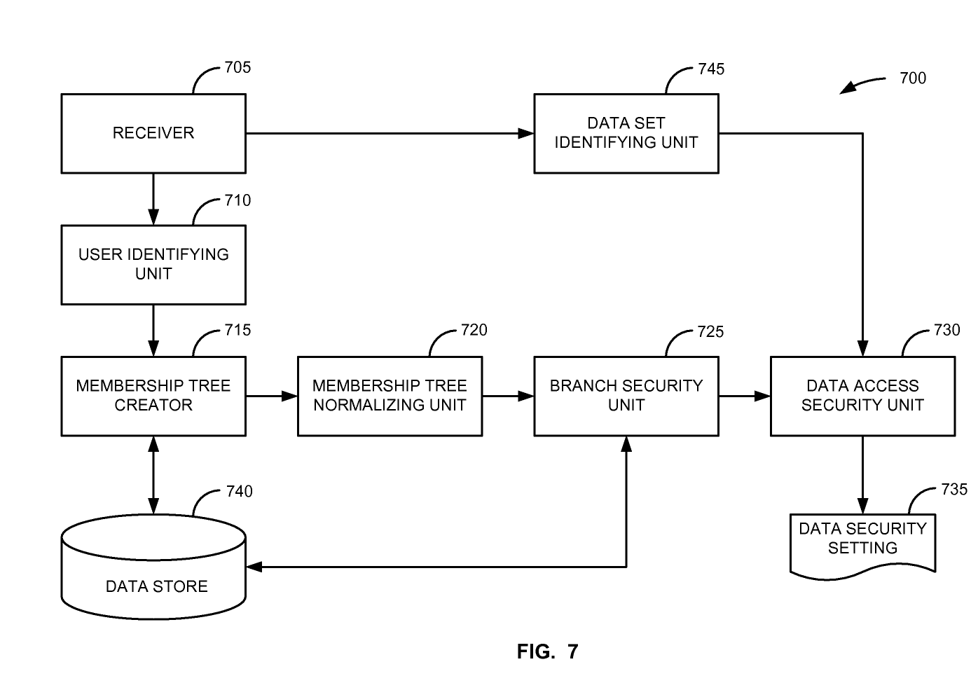

FIG. 7 is a detailed block diagram of a system for computing the data security setting for accessing the dataset according to an embodiment of the invention. System 700 includes a receiver 705 to receive a request from a user to access a dataset. In an embodiment, the request may include details such as user identification (ID), type of data requested such as sales data, customer data, and materials data. A user identifying unit 710 connected to receiver 705 identifies the user requesting access to the dataset. A membership tree creator 715 connected to data store 740 creates a membership tree of the user by retrieving membership details of the user from data store 740. The membership tree is created as a tree structure with branches and nodes. The user and user groups form the nodes of the membership tree. The membership tree provides details such as names of user groups the user belongs to, type of membership of the user with each of the user groups, for example, direct member or indirect member and relationship between the user groups. The membership tree also has the details of data security settings of the user and the user groups.

A membership tree normalizing unit 720 normalizes the membership tree to obtain the set of minimal branches for the user. A minimal branch is a smallest branch in the membership tree that necessarily determines a data security setting for the user to access the dataset. In other words, a minimal branch is the shortest path between two nodes. The membership tree normalizing unit 720 normalizes the membership tree by splitting the membership tree into branches and then removing the non-minimal branch by performing Boolean set operations on the branches.

A branch security unit 725 connected to membership tree normalizing unit 720 determines a minimal data security setting for the user based on the set of minimal branches. The branch security unit 725 retrieves the data security settings of the user and the user groups from data store 740 and computes the minimal data security setting.

A dataset identifying unit 745 connected to receiver 705 identifies a data source for the dataset the user is requesting access to based on the type of data requested. In an embodiment, the data source may be an OLAP cube such as sales cube. A data access security unit 730 connected to branch security unit 725 and data set identifying unit 745 determines the data security setting 735 for the user to access the dataset based on the minimal data security setting. For example, in a multi dimensional database environment having an OLAP cube as the data provider, data security setting 735 to access the OLAP cube is determined by computing the data security setting for a particular dimension and a metric of the OLAP cube. After determining data security setting 735, data access security unit 730 embeds data security setting 735 in the query to retrieve the dataset.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or any other type of machine-readable media suitable for tangibly storing electronic instructions. The machine readable medium can provide the instructions stored therein to a computer system comprising a processor capable of reading and executing the instructions to implement the method steps described herein.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. The detailed description as set forth above includes descriptions of method steps. However, one skilled in the art will understand that the order of the steps set forth above is meant for the purposes of illustration only and the claimed invention is not meant to be limited only to the specific order in which the steps are set forth. Accordingly, the scope and spirit of the invention should be judged in terms of the claims which follow.

What is claimed is:

1. An article of manufacture, comprising:
a machine readable medium having instructions which when executed by a machine cause the machine to perform operations comprising:
retrieving a membership tree of a user requesting access to a dataset;
determining a set of minimal branches of the membership tree;
determining a minimal data security setting for the user by computing a sum of products in the set of minimal branches; and
determining a data security setting for the dataset based on the minimal data security setting.

2. The article of manufacture of claim 1 further comprising embedding the data security setting in a query to access the dataset.

3. The article of manufacture of claim 1, wherein determining a set of minimal branches comprises:
splitting the membership tree into branches;
determining a product of nodes in the branches;
determining a sum of the product of nodes; and
performing Boolean operations on the sum of the product of nodes to remove non-minimal branches.

4. The article of manufacture of claim 3, wherein a node in a branch represents a group to which the user belongs.

5. The article of manufacture of claim 3, wherein the Boolean algebra operation comprises an operation selected from a group consisting of idempotent law, absorption law and distributive law.

6. The method of claim 1, wherein determining a minimal data security setting comprises:
adding the user as a leading factor of a sum of product of nodes;
substituting the user and the nodes with data security settings of the user and the nodes respectively; and
computing the minimal data security setting for the user to access the data set.

7. The article of manufacture of claim 1, wherein determining a data security setting for the dataset comprises:
computing a data security setting for a dimension in an online analytical processing (OLAP) cube based on the minimal data security setting; and
computing a data security setting for a metric in the OLAP cube based on the minimal data security setting.

8. The article of manufacture of claim 7, wherein computing a data security setting for the dimension comprises computing the data security setting using set operators selected from a group consisting of “UNION” and “INTERSECTION”.

9. The article of manufacture of claim 7, wherein computing a data security setting for the metric comprises computing the data security setting using binary operators selected from a group consisting of “AND” and “OR”.

10. The article of manufacture of claim 7, wherein a data security setting for a dimension has a default value of FULL SET and a data security setting for a metric has a default value of true.

11. The article of manufacture of claim 1, wherein the sum of products comprises a sum of product of nodes in set of minimal branches.

12. The article of manufacture of claim 1, wherein the user and a group to which the user belongs are members of the data security setting.

13. The method of claim 1 further comprising maintaining the dataset as an OLAP cube.

14. A computer system including a processor and a memory, the memory comprising instructions that are executable by the processor, the instructions comprising:
a receiver to receive a query for accessing a dataset;
a user identifying unit in communication with the receiver to identify a user requesting the access;
a data set identifying unit in communication with the receiver to identify a data set for which access is requested by the user;
a membership tree creator in communication with the user identifying unit to create a membership tree of the user;
a membership tree normalizing unit in communication with the membership tree creator to determine a set of minimal branches of the membership tree;
a branch security unit in communication with membership tree normalizing unit to compute a minimal data security setting for the user based on the set of minimal branches; and
a data access security unit in communication with the branch security unit and the data set identifying unit to determine a data security setting for the dataset based on the minimal data security setting.

15. The system in claim 14 further comprising a query engine in communication with a data security engine to execute a query with the data security setting to obtain the dataset.

16. The system in claim 14 further comprising a semantic layer in communication with a database containing a data model describing the dataset contained in the database.

17. The system in claim 14 further comprising a datastore in communication with the membership tree creator to persist the membership tree of the user, data security settings of the user and data security settings of a group to which the user belongs.

18. A computer implemented method for computing a data security setting for a user requesting access to a dataset in a multidimensional system, the method comprising:
retrieving a membership tree of a user requesting access to a dataset;
determining a set of minimal branches of the membership tree;
determining a minimal data security setting for the user by computing a sum of products in the set of minimal branches;
determining a data security setting for the dataset based on the minimal data security setting; and
embedding the data security setting in a query to access the dataset.

19. The method in claim 18 further comprising instructions for:
splitting the membership tree into branches;
determining a product of nodes in the branches;
determining a sum of the product of nodes; and
performing Boolean operations on the sum of the product of nodes to remove non-minimal branches.

20. The method in claim 18 further comprising instructions for:
adding the user as a leading factor of a sum of the product of nodes;
substituting the user and the nodes with data security settings of the user and the nodes respectively; and
computing the minimal data security setting for the user to access the dataset.
